(19) United States
(12) Patent Application Publication
(10) Pub. No.: US 2021/0372149 A1
(43) Pub. Date: Dec. 2, 2021

(54) SYSTEM AND METHOD FOR RAPID BARRIER DEPLOYMENT

(71) Applicant: WallTainer, Inc., Sarasota, FL (US)

(72) Inventor: Jeffrey GOULD, Sarasota, FL (US)

(21) Appl. No.: 17/337,349

(22) Filed: Jun. 2, 2021

Related U.S. Application Data
(60) Provisional application No. 63/033,823, filed on Jun. 2, 2020.
(60) Provisional application No. 63/188,875, filed on May 14, 2021.

(51) Int. Cl. E04H 1/12; E04B 1/348; F41H 5/24; B65D 88/12

(52) U.S. Cl. CPC E04H 1/1205; E04B 1/3483; B61B 13/00; B65D 88/121; E04H 2001/1283; F41H 5/24

(57) ABSTRACT

A system, method and program product for developing and deploying a rapidly deployable barrier system. The present disclosure further relates to a rapidly deployable barrier system that provides an expandable set of optional features that may be employed when the rapidly deployable barrier system deployed.

### FIELD OF THE INVENTION

The present disclosure relates generally to systems and methods for securing, transporting and upcycling shipping containers, and more particularly to, but not by way of limitation, to a system and method for rapid deployment of barriers and shelters.

### BACKGROUND

The majority of freight shipped overseas is now shipped containers of standard sizes; usually eight and one half (81/2) feet high, eight (8) feet wide and twenty (20) or forty (40) feet long. These shipping containers are very strong. However, after considerable use, they become uneconomical to use as shipping containers and they are taken out of service. What is needed is an improved system and method to recycle this excess economically.

Similarly, barrier control systems are known in which a gate or barrier is deployed to control access or limit movement of persons within a security area. Rapidly deployable barrier control systems are often temporary and highly penetrable. Permanent barrier control systems are difficult to construct, time consuming to complete and are often highly penetrable. Additionally, shelter systems are known in which a temporary structure is deployed to provide a secure area. Such shelter systems, however, are often highly penetrable and susceptible to the surrounding environment. Permanent shelters able to withstand wide variations in the surrounding environment are difficult to construct and time consuming to complete.

Therefore, it is desired to have an improved rapidly deployable construction and control systems that is economical and highly impenetrable. The claimed invention addresses these described needs.

### SUMMARY

The claimed invention fulfills these needs and has been developed in response to the present state of the art, and in particular, in response to the problems and needs in the art that have not yet been fully solved by currently available technologies.

One aspect of the claimed invention provides for a system for rapidly barrier deployment, comprising: a plurality of prefabricated segments, each having a top, a bottom, first and second sides, and first and second ends; arranging the prefabricated segments to form a barrier

Another aspect provides an apparatus comprising: a parallelepiped frame; a plurality of outer walls fixed to the frame such that each outer side of the apparatus is formed by a different one of the plurality of outer walls; a floor forming a bottom of the apparatus and a ceiling forming a top of the apparatus, the floor and ceiling being fixed to the frame; and an inner wall fixed to the frame to form an inner side of the apparatus, the inner wall being adjacent to one of the outer walls; the adjacent one outer wall being removeably fixed to the frame so as to be removable to transition the apparatus from a shipping container configuration, in which the plurality of outer walls are affixed to the frame, to a building fixture configuration, in which the inner wall is an external wall of a building.

Yet another aspect of the claimed invention provides a deployable barrier system for closing a security area to passage therethrough, the barrier system comprising: at least one deployable prefabricated segment which is movable between an undeployed position in which the prefabricated segment is disposed in a first location in which the security area is open to passage therethrough, and a fully deployed position in which the prefabricated segment is disposed in a second location different from the first location, whereby the security area is closed to any such passage therethrough, the prefabricated segment being comprised of a ballistic material along substantially its entire length; a control system operatively connected to controlled prefabricated segment and capable of being activated to move the controlled prefabricated segment between the undeployed position and the fully deployed position; wherein the controlled prefabricated segment is configured to enable, at a selected time after controlled prefabricated segment is in the fully deployed position, formation in the fully deployed prefabricated segment of at least one limited access opening to the security area.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1(a) illustrates a schematic diagram of a container according to an embodiment herein.

FIG. 1(b) illustrates a schematic diagram of various containers according to an embodiment herein.

FIGS. 2(a)-(c) illustrates a schematic diagram of deployable barrier system according to an embodiment herein.

FIG. 3 illustrates a cross-sectional schematic diagram of a deployable barrier system according to an embodiment herein.

FIG. 4 illustrates an alternative cross-sectional schematic diagram of a deployable barrier system according to an embodiment herein.

FIGS. 5(a)-5(c) illustrates a schematic diagram of deployment of a deployable barrier system according to an embodiment herein.

FIG. 6 illustrates a schematic diagram of deployment of a deployable barrier system at different grades according to an embodiment herein.

FIG. 7 illustrates another schematic diagram of deployment of a deployable barrier system according to an embodiment herein.

FIG. 8 illustrates a schematic diagram of a top section of the deployable barrier system, with an optional rail system, according to an embodiment herein.

FIG. 9(a) illustrates a schematic diagram of a top section of the deployable barrier system, with a solar energy support system, according to an embodiment herein.

FIG. 9(b) illustrates a schematic diagram of the deployable barrier system, with a solar energy support system, according to an embodiment herein.

FIG. 9(c) illustrates a schematic diagram of a solar energy support system for the deployable barrier system according to an embodiment herein.

FIGS. 10(a) and 10(B) illustrate schematic diagrams of a sound barrier system according to an embodiment herein.

FIGS. 11(a)-11(d) illustrate technical diagrams of a sound barrier system according to an embodiment herein.

FIG. 12 illustrates another schematic diagram of a sound barrier system according to an embodiment herein.

FIG. 13 illustrates a cutaway view of a sound barrier system according to an embodiment herein.

FIG. 14 illustrates a perspective view of a sound barrier system according to an embodiment herein.

FIG. 15 illustrates another cutaway view of a sound barrier system according to an embodiment herein.

FIG. 16 illustrates another perspective view of a sound barrier system according to an embodiment herein.

FIG. 17 illustrates detailed schematic diagram of a sound barrier system according to an embodiment herein.

FIG. 18 illustrates a schematic diagram of a solar energy support system for the deployable barrier system according to an embodiment herein.

FIGS. 19(a) and 19(b) illustrate additional schematic diagrams of a solar energy support system for a sound barrier system according to an embodiment herein.

FIGS. 20(a) and 20(h) illustrate schematic diagrams of a solar charging station according to an embodiment herein.

FIG. 21 FIG. 18 illustrates a schematic diagram of a solar energy support system for the deployable sound barrier system according to an embodiment herein.

FIG. 22 illustrates a schematic diagram of a management method according to an embodiment herein.

FIG. 23 illustrates a schematic diagram of a deployable management system according to an embodiment herein.

### DETAILED DESCRIPTION OF PREFERRED EMBODIMENTS

The claimed invention relates generally to the systems, methods and arrangements for improved techniques for developing and deploying a rapidly deployable barrier system. The claimed invention further relates to a rapidly deployable barrier system that provides an expandable set of optional features that may be employed when the rapidly deployable barrier system deployed. The claimed invention also relates to a rapidly deployable sound barrier system that provides an expandable set of optional features that may be employed when the rapidly sound deployable barrier system deployed. The claimed invention further relates to a rapidly deployable shelter system that provides an expandable set of optional features that may be employed when the rapidly deployable shelter system deployed.

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

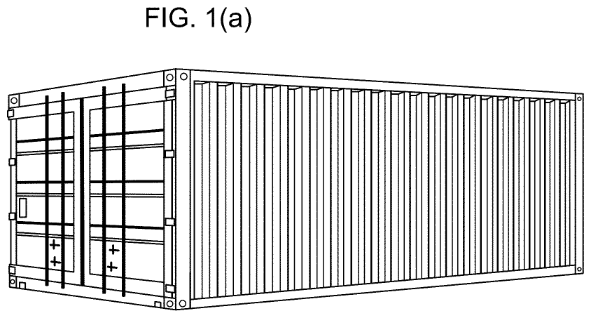

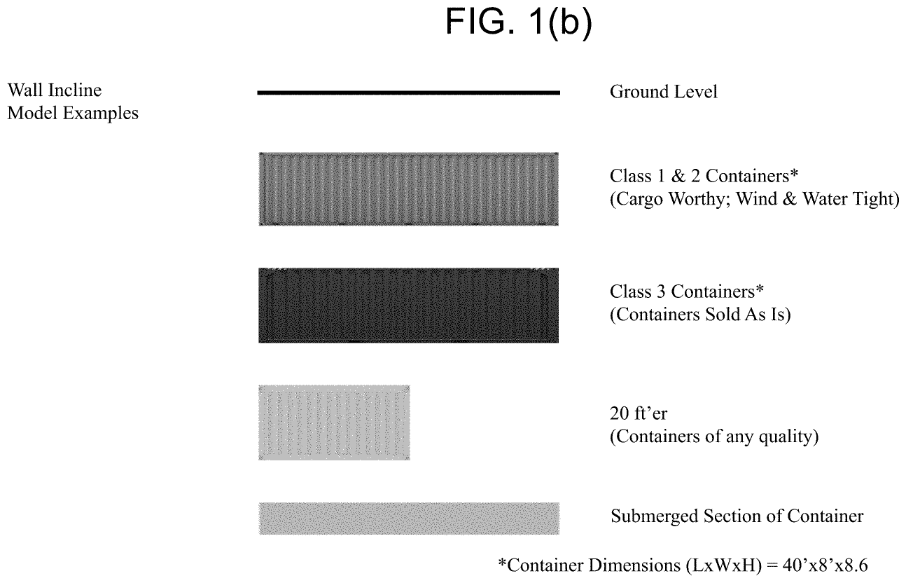

Turning now to the figures, FIG. 1(a) illustrates a schematic diagram of a container according to an embodiment herein. FIG. 1(b) further illustrates a schematic diagram of various containers according to an embodiment herein. As used herein, the terms “intermodal containers,” “storage containers,” “shipping containers” and “container” are synonymous. Collectively, these terms are intended to include all containers used in overseas shipment and particularly such containers conforming to an international standard (e.g., ISO 6346). These containers are typically made of steel and as shown in the figures, have a box-like frame of steel members, a bottom wall of steel channel beams attached to the frame and wood slats wedged therebetween, a top wall, two opposed sidewalls of corrugated steel sheets welded to the frame, and two opposed steel end walls connected to the frame, one end wall of which includes two outwardly swinging steel doors. Each corner of the frame includes a special metal fitting adapted to pass a steel cable therethrough. These fittings are used for lifting and lowering the container and for anchoring the containers to one another to prevent shifting and toppling in their transport vehicle.

Without limiting the present disclosure in any way, most containers conform to one of three ISO container types; 20GP, 40GP, and 40HC. Generally, such containers are usually eight and one half (81/2) feet high, eight (8) feet wide and twenty (20) or forty (40) feet long. Other ISO container types also available and include, as a non-limiting example, 10GP, 20HC, 45HC, and 53HC. The quality of such containers may be described as follows:

One-Tripper or New Container—These are containers that have been newly manufactured and shipped directly from China carrying their first load of cargo. They generally have the latest features like polyurethane floor coating to protect from spills, a pre-installed lockbox, and easily accessible handles and doors.

Cargo Worthy—These are containers that have been deemed cargo worthy by a certified marine surveyor. Containers that are cargo worthy are still qualified for use in the shipping industry. They have been deemed wind-proof and waterproof.

Wind and Water Tight (WWT) ‘Grade A’ Container—These are ‘Grade A’ containers that are 8 years or older but have little rust or damage. They are certified wind and watertight.

Wind and Water Tight (WWT) ‘Grade B’ Container—These are ‘Grade B’ containers that are 8 years or older and have a significant amount of rust or damage. They are no longer deemed cargo-worthy for the shipping industry but are usually suitable for storage.

Premium or IICL-5 Containers—These are containers that are 2-8 years old and in excellent condition. They meet all repair standards and are qualified for regular cargo use. They usually cost less than a new container, but more than WWT containers that are 8 years or older.

Refurbished Container—These are used containers that have been repaired. They may have had dents removed, floors replaced, new doors or a new paint job. The price will vary based on the quality of repairs.

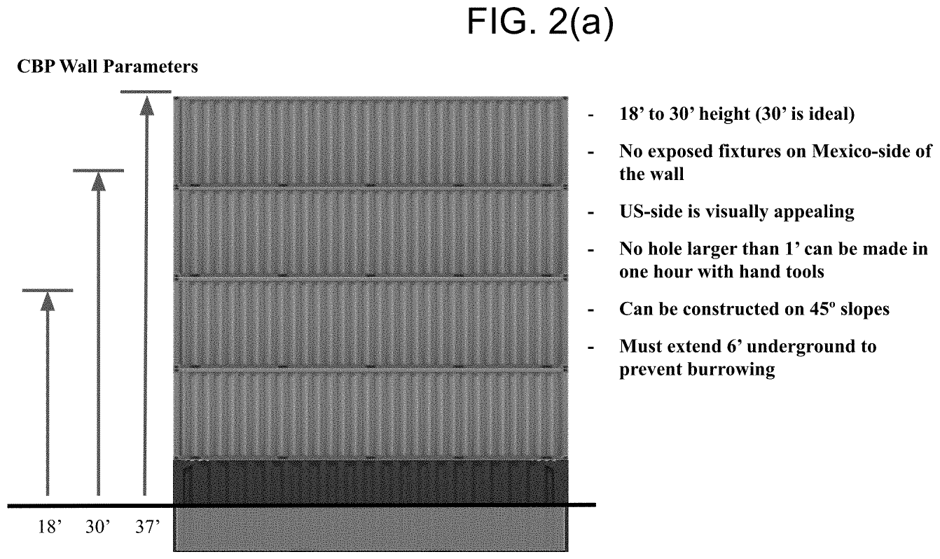

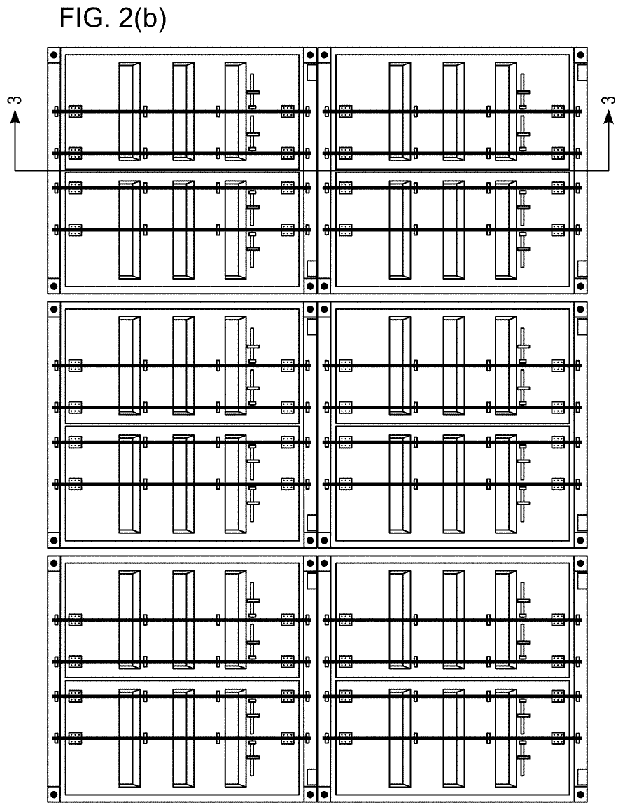

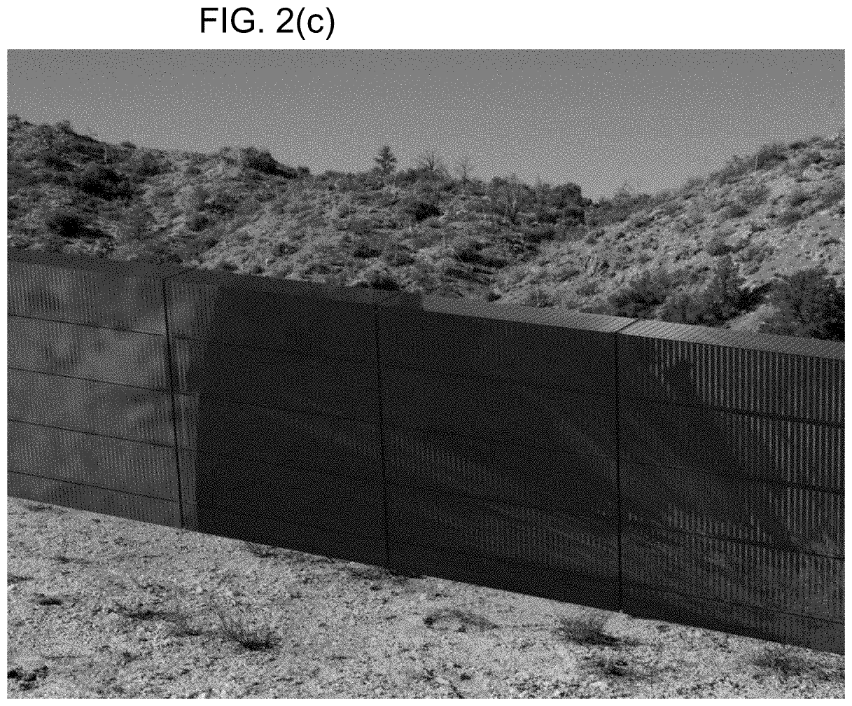

FIGS. 2(a)-(c) illustrates a schematic diagram of deployable barrier system according to an embodiment herein. According to the figures shown, the disclosed deployable barrier system is not limited in either height, width or depth and may include, for example, a height of 18 to over 30 feet, with a preferable embodiment of over 30 feet. Options include a visually appealing façade (such as a visually appealing US-side when deployed along the US-Mexico border) and may exclude exposed fixtures on one side of the barrier (e.g., no exposed fixtures on the Mexico-side when deployed along the US-Mexico border). The disclosed deployable barrier system further includes highly impenetrable features, including restrictions on boring with portable tools (e.g., no hole larger than 1 inch can be made in one hour with hand tools), ballistic analysis, projectiles and tunnel prevention (e.g., deploying the disclosed deployable barrier system on 45 degree slopes and extending sections of the deployable barrier system 6 feet underground to prevent burrowing).

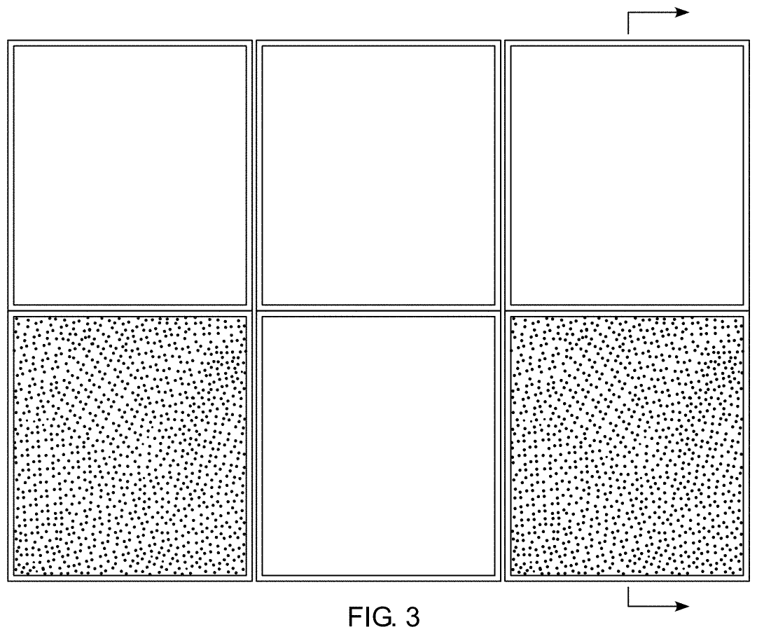

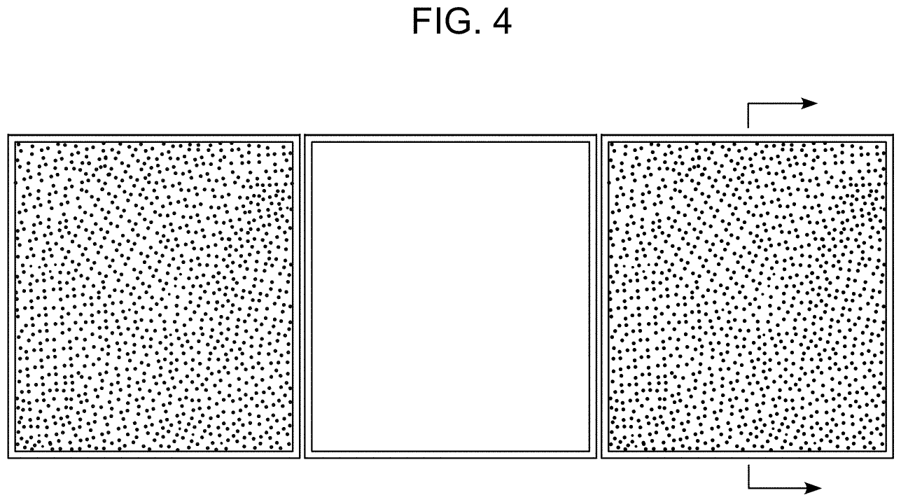

Further impenetrable features are shown in FIGS. 3 and 4, where FIG. 3 illustrates a cross-sectional schematic diagram of a deployable barrier system according to an embodiment herein and FIG. 4 further illustrates an alternative cross-sectional schematic diagram of a deployable barrier system according to an embodiment herein. As shown in FIGS. 3 and 4, certain containers that comprise the disclosed deployable barrier system contain a volume of material (e.g., a granular materials). Such material may include, for example, sand, gravel and larger rocks.

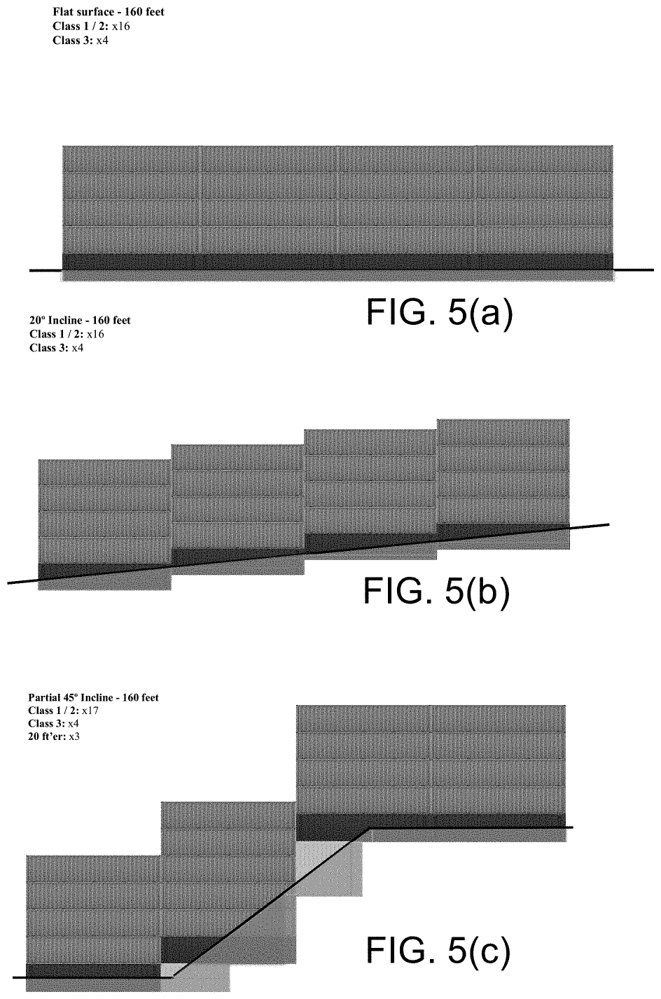

FIGS. 5(a)-5(c) illustrates a schematic diagram of deployment of a deployable barrier system according to an embodiment herein. As shown in the figures, various deployments are possible along a wide range of terrain. For example, FIG. 5(a) illustrates a schematic diagram the disclosed deployable barrier system being deployed on flat terrain. FIGS. 5(b) and 5(c) illustrates schematic diagrams of the disclosed deployable barrier system being deployed on an incline (such as a 20-degree include in FIG. 5(b) or a 45-degree incline in FIG. 5(c). One of ordinary skill in the art, however, will readily recognize that there could be countless variations to FIGS. 5(b) and 5(c) and those variations would be within the spirit and scope of the claimed invention.

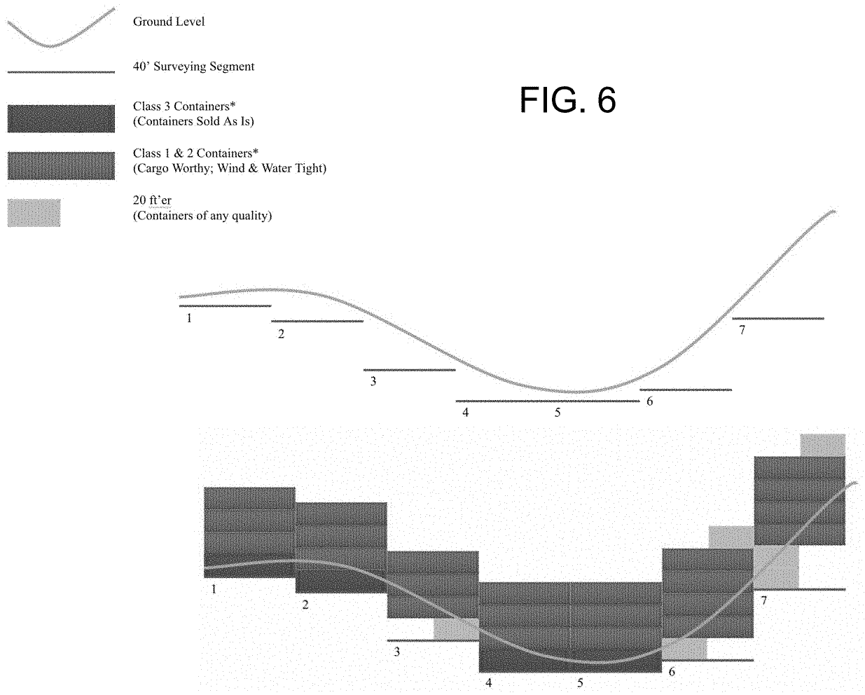

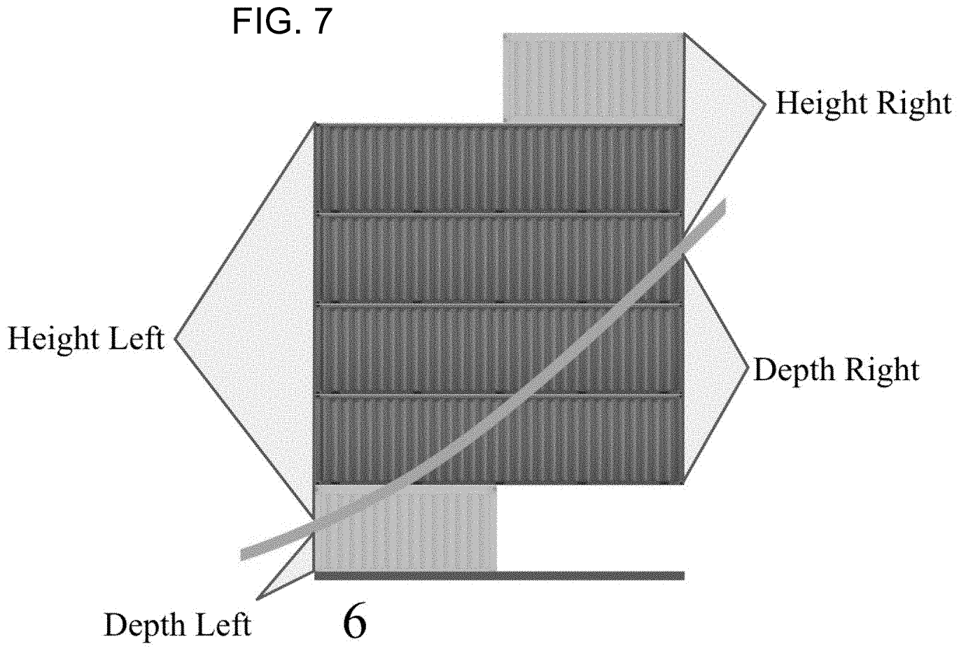

FIG. 6 illustrates a schematic diagram of deployment of a deployable barrier system at different grades according to an embodiment herein. FIG. 7 illustrates another schematic diagram of deployment of a deployable barrier system according to an embodiment herein. As disclosed, the deployable barrier system utilizes prefabricated sections. As shown in the figures, the prefabricated sections comprise shipping containers of various sizes. For example, to create the border wall along the US-Mexico border according to Customs and Border Patrol (CBP) specifications using the disclosed deployable barrier system, a 6′ trench would be dug, and the prefabricated sections would stacked between 18′ to 30′ above the surface.

According to FIGS. 6 and 7, the prefabricated sections are configured in two lengths: 20 feet and 40 feet. For example, assuming a length of 40 feet for each prefabricated section, each mile of the rapidly deployable barrier would require 132 individual prefabricated sections (132×40 ft=5280 ft, 1 mi). Depending on the topography of that distance, as shown in the figures, each section would be labeled accordingly (described in further detail below). As discussed further below, over longer distances, using the prefabricated sections described above, the surveying, planning, and construction teams utilizing the disclosed deployable barrier system plans according to individual segments (e.g., each segment is 40 feet and corresponding to the length of a container or prefabricated section). To further optimize construction of the rapidly deployable barrier system disclosed herein, the deployable barrier system may leverage a combination of 20-foot and 40-foot containers to utilize the least amount of containers while meeting design parameters. Furthermore, as described in further detail below, the embodiments disclosed herein provide a highly repairable deployable barrier.

FIG. 6, for example, illustrates an approach according to the deployable barrier system described herein that divides a certain terrain into 40-foot sections. As shown, the topography of 280 feet is simplified into 7 different prefabricated segments of the disclosed deployable barrier system. While not shown in FIG. 6, each section of 7 different prefabricated segments of the disclosed deployable barrier system may either be repaired or replaced with another prefabricated segment. Furthermore, the terrain includes steep inclines in labeled sections 6 and 7.

While not shown in FIG. 6, each labeled section of FIG. 6 would be designed by dividing the section and prefabricated segments into at least four metrics: 1) depth on the left; 2) depth on the right; 3) height on the left; and 4) height on the right. One of ordinary skill in the art, however, will readily recognize that there could be countless variations to the four metrics described above and those variations would be within the spirit and scope of the claimed invention. As further shown in FIG. 6, mixed sizes of prefabricated segments may be used to optimize the configuration of the rapidly deployable barrier system to match the terrain. Such optimizations are incorporated into the deployment, repair and management plan, described in further detail below. For example, to offset the use of 40-foot containers in steep sections, FIG. 6 illustrates a rapidly deployable barrier system that utilizes a combination of prefabricated sections that are 20 feet and 40 feet in length. As discussed above, each section of the disclosed deployable barrier system may either be repaired or replaced with another prefabricated segment according to the specifications of the assigned label to the particular prefabricated segment to be replaced. The specifications of the prefabricated segment assigned to a specific label identifier, in turn, are determined according to the survey conducted of the planned barrier pathway and the deployment and construction plan of the barrier. In certain embodiments, each specific label identifier is unique, with a unique set of specifications, such that individual identifiers can be replaced through the barrier system so long as the specifications match. In other embodiments, each specific label identifier is unique, with a non-unique set of specifications, such that then entire barrier deployment will comprise a sequence of non-repeating identifiers where the length of the sequence is equal to the total number of prefabricated segments in the deployable barrier.

FIG. 7 illustrates a close-up view of section 6 of the terrain shown in FIG. 7 and outlines the four metrics described above for each section; according to the figures, such metrics include: height left, height right, depth left, and depth right. These metrics are adjustable based on the parameters for the rapidly deployable barrier system—for example, to meet CBP Parameters, the height metrics must measure between 18 feet to 30 feet on both ends while the depth metrics must measure at least 6-foot deep on both ends.

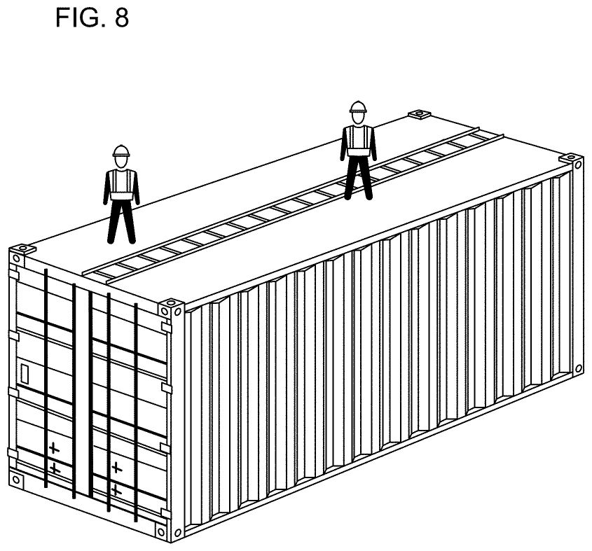

FIG. 8 illustrates a schematic diagram of a top section of the deployable barrier system, with an optional rail system, according to an embodiment herein. As shown in the figures, the disclosed deployable barrier system may include an optional rail system to transport persons or cargo along the deployed length of the deployable barrier system. FIG. 8 illustrates a portion of the deployable barrier system that includes a top portion. As illustrated, the top portion includes a top of a shipping container. Connected to the top portion is a section of rail, where the rail is gauged to accept railcars (not shown) of compatible sizes.

While not shown in FIG. 8, a railcar may include a configuration to support the transport of persons, cargo or both. A plurality of railcars may form a train that operates along the length of the disclosed deployable barrier system and the train may comprise railcars configuration to support the transport of persons, cargo or both. The railcars, or train, may include a power source (such as fuel-powered engine, where such fuel may include gasoline, diesel, hydrogen, water, etc.) or may rely on an external power source (such as electricity, where the electricity may come from a publicly available power grid, a solar energy support system (e.g., as described below), etc.) One of ordinary skill in the art, however, will readily recognize that there could be countless variations to FIGS. 5(b), 5(c) and 8 and those variations would be within the spirit and scope of the claimed invention.

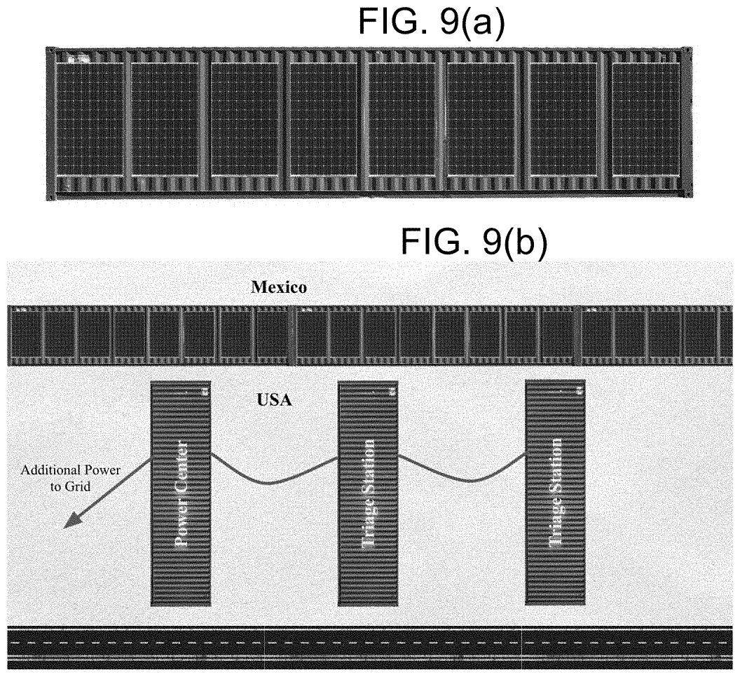

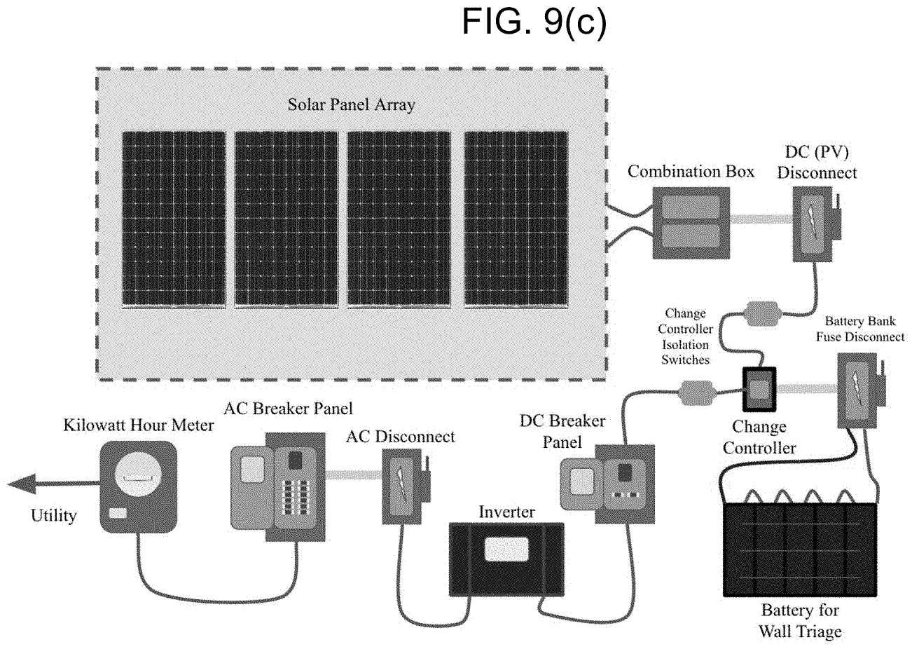

FIG. 9(a) illustrates a schematic diagram of a top section of the deployable barrier system, with a solar energy support system, according to an embodiment herein. Additionally, FIG. 9(b) illustrates a schematic diagram of the deployable barrier system, with a solar energy support system, according to an embodiment herein. FIG. 9(c) illustrates a schematic diagram of a solar energy support system for the deployable barrier system according to an embodiment herein. As shown in the figures, the disclosed solar energy support system includes a number of solar panels (e.g., eight solar panels are shown in FIG. 9(a) either on a top section of the deployable barrier system or on top of a container. In addition to being incorporated into the disclosed deployable barrier system (e.g., as shown in FIG. 9(b)), the disclosed solar energy support system is shown in FIG. 9(c) as including: a solar panel array; a combination box; a DC (PV) Disconnect; Change Controller Isolation Switches; a Change Controller; a Battery Bank Fuse Disconnect and a Battery (e.g., Battery bank for Wall Triage); a DC Breaker Panel; Inverter; an AC Disconnect; an AC Breaker Panel; and a Kilowatt Hour Meter. However, one of ordinary skill in the art will readily recognize that there could be variations to FIGS. 9(a)-9(c) and those variations would be within the spirit and scope of the claimed invention.

For example, as shown in the figures, each power station of FIG. 9(b) includes a grid-tied power center, all housed within a shipping container. Such power centers may be located according to need of the overall deployable barrier system and solar panel array, each with a complimenting triage station. The electricity harvested serve a dual purpose of powering the triage stations along the deployable barrier system and delivering energy to the utility grid. Triage stations may include shelters, medical facilities, repose stations, holding cells, and surveillance monitoring stations. As show in FIG. 9(c), a portion of the electricity harvested by the solar panels will optionally be sent back to a public grid; for example, to be publicly available following the charging of the triage station batteries.

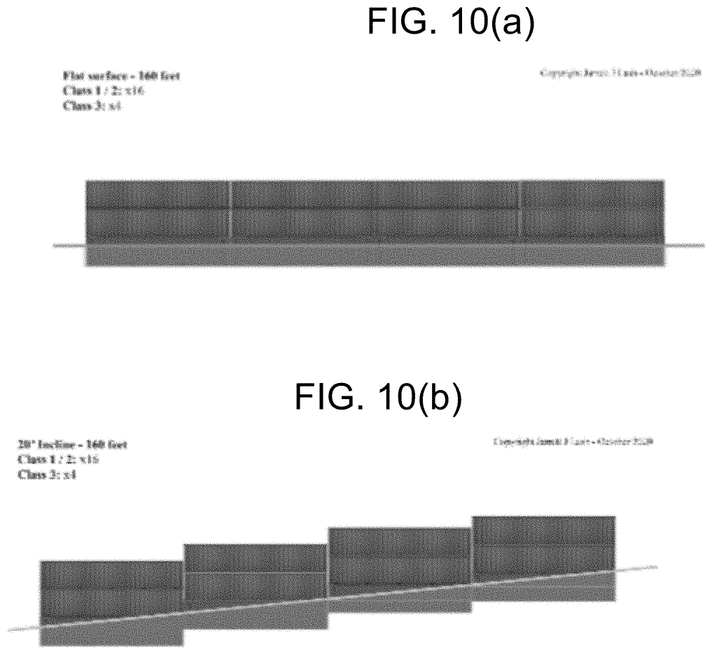

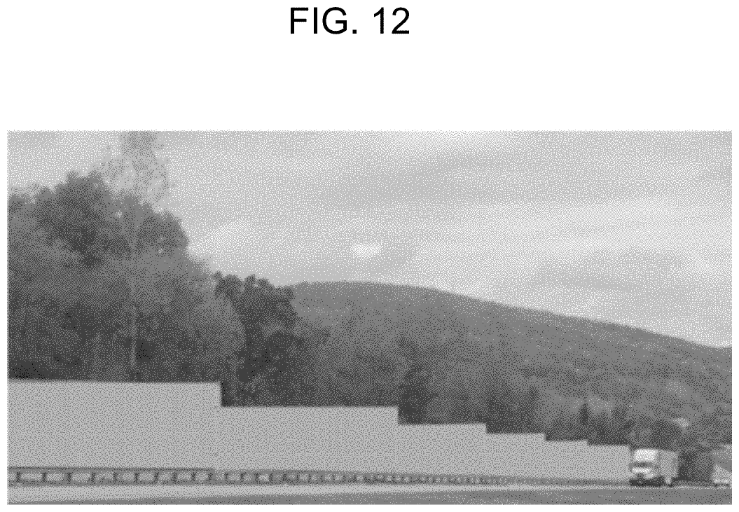

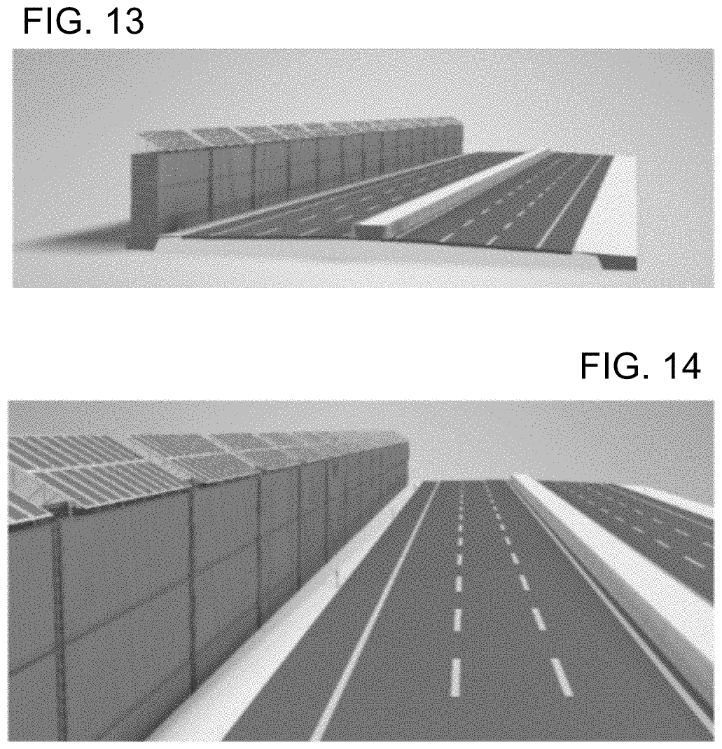

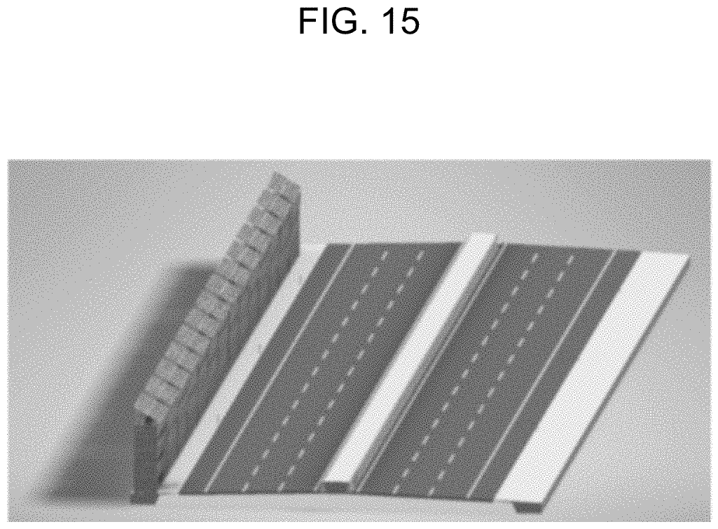

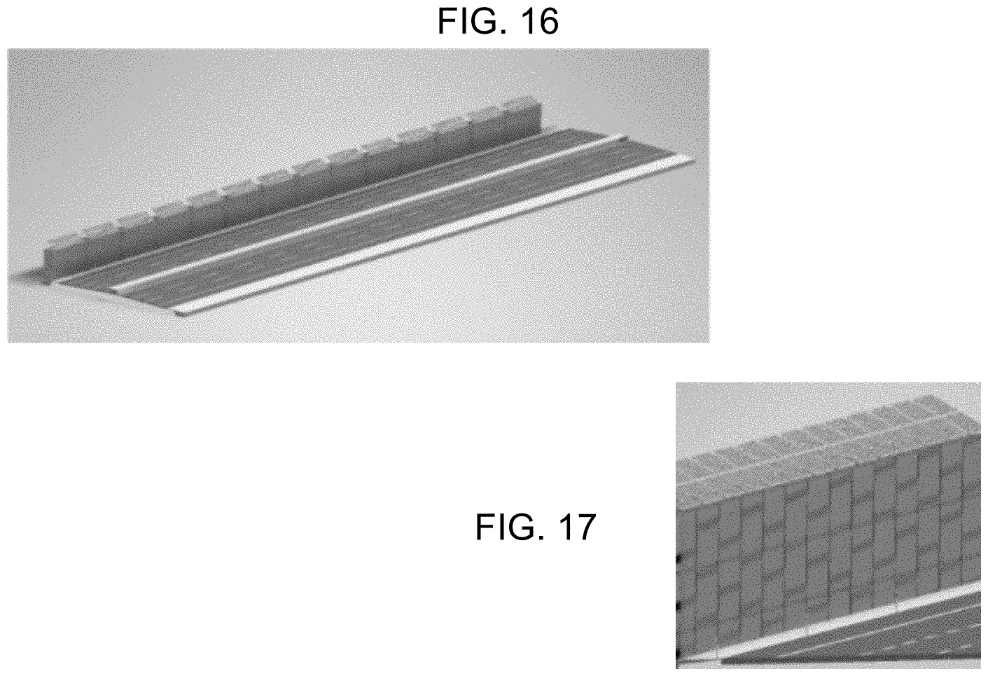

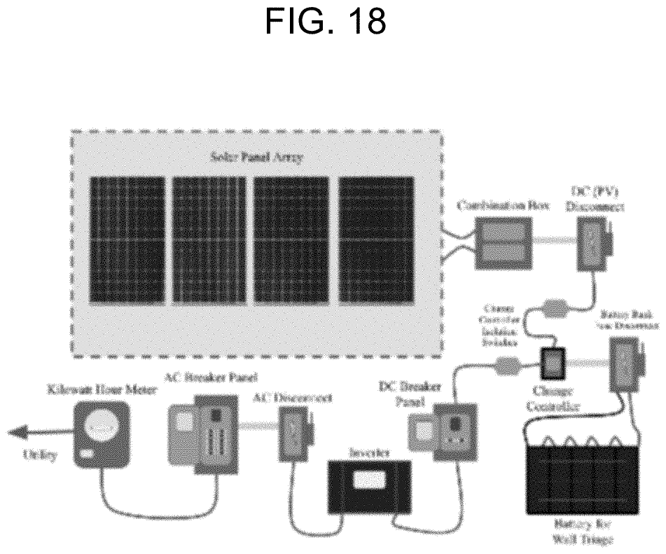

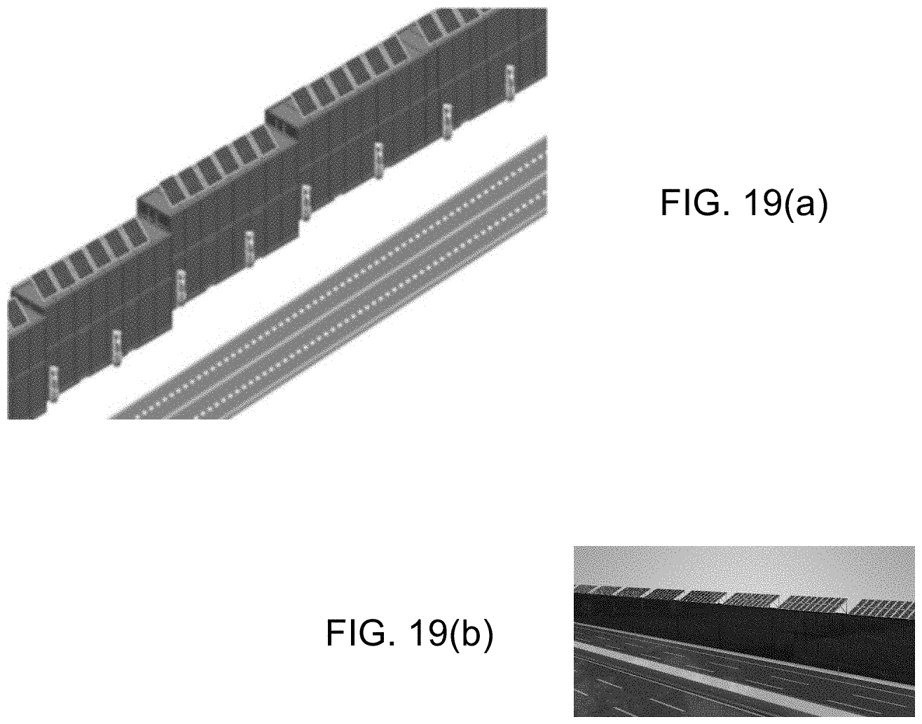

FIGS. 10(a)-19(b) illustrates a schematic diagram of deployment of a deployable sound barrier system, including a sound barrier system deployed at different grades, according to an embodiment herein. As disclosed, the deployable sound barrier system utilizes prefabricated sections. As shown in the figures, the prefabricated sections comprise shipping containers of various sizes. For example, to create the sound border wall along a highway according to an embodiment, a 6′ trench would be dug, and the prefabricated sections would stacked between 18′ to 30′ above the surface.

According to FIGS. 10(a)-19(b), prefabricated sections are configured in two lengths: 20 feet and 40 feet. For example, assuming a length of 40 feet for each prefabricated section, each mile of the rapidly deployable barrier would require 132 individual prefabricated sections (132×40 ft=5280 ft, 1 mi). Depending on the topography of that distance, as shown in the figures, each section would be labeled accordingly (described in further detail below). Thus, over longer distances, using the prefabricated sections described above, the surveying, planning, and construction teams utilizing the disclosed deployable barrier system plans according to individual segments (e.g., each segment is 40 feet and corresponding to the length of a container or prefabricated section). To further optimize construction of the rapidly deployable sound barrier system disclosed herein, the deployable barrier system may leverage a combination of 20-foot and 40-foot containers to utilize the least amount of containers while meeting design parameters.

FIGS. 10(b), 12 and 19(a), for example, illustrate an approach according to the deployable barrier system described herein that divides a certain terrain into 40-foot sections. As shown, the topography of 280 feet is simplified into 4 different prefabricated segments of the disclosed deployable sound barrier system. Furthermore, the terrain includes steep inclines in labeled sections 6 and 7.

While not shown in FIGS. 10(a)-19(b), each labeled section of the deployable sound barrier system would be designed by dividing the section and prefabricated segments into at least four metrics: 1) depth on the left; 2) depth on the right; 3) height on the left; and 4) height on the right. One of ordinary skill in the art, however, will readily recognize that there could be countless variations to the four metrics described above and those variations would be within the spirit and scope of the claimed invention. As further shown in FIGS. 10(b), 12 and 19(a), mixed sizes of prefabricated segments may be used to optimize the configuration of the rapidly deployable sound barrier system to match the terrain. For example, to offset the use of 40-foot containers in steep sections, FIG. 10(b) illustrates a rapidly deployable barrier system that utilizes a combination of prefabricated sections that are 20 feet and 40 feet in length.

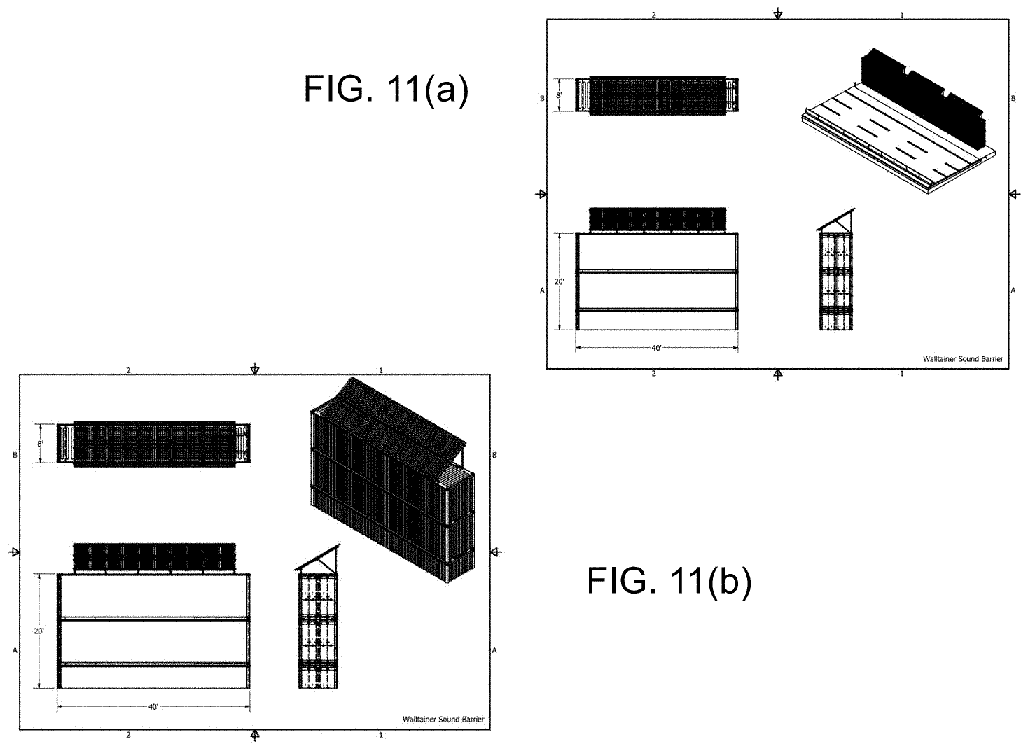

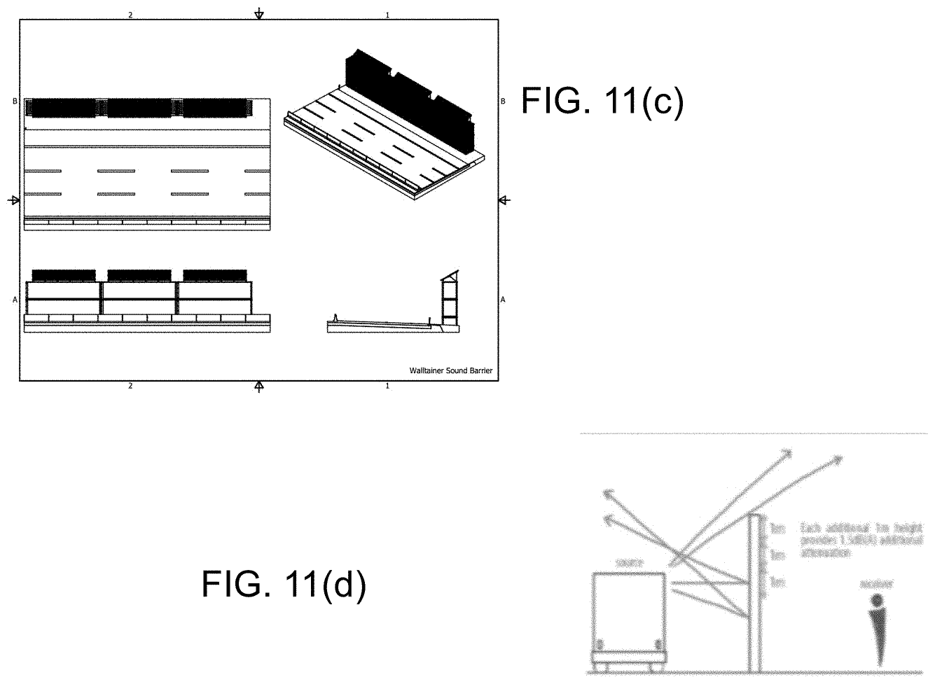

Prior to excavation, a comprehensive excavation plan will be developed dividing the sections to direct the amount of digging required and so containers can be placed directly upon arrival at the site. For example, FIGS. 11(a)-11(d) illustrates a close-up view of section 6 of the terrain shown in FIGS. 10(a) and 10(b), and outlines the four metrics described above for each section; according to the figures, such metrics include: height left, height right, depth left, and depth right. These metrics are adjustable based on the parameters for the rapidly deployable sound barrier system—for example, to meet certain U.S. Department of Transportation mandates, Federal Highway Administration recommendations or other general Highway Control Parameters, the height metrics must measure between 18 feet to 30 feet on both ends while the depth metrics must measure at least 6-foot deep on both ends. Furthermore, as described above with respect to the deployable barrier systems, the embodiments of the sound barrier disclosed herein provide a highly repairable deployable sound barrier in a manner similar to that which has been described above with respect to the deployable barrier systems.

Additional applications of the disclosed sound barrier system include, but are note limited to: Highways, Rail lines, Electrical Substations, Loading Docks, “Big Box” Developments, Schools and Hospitals, Bridges and Weight Sensitive Structures, Power Plants, Bus Depots, Multi-family housing, Gun Ranges and Military Facilities.

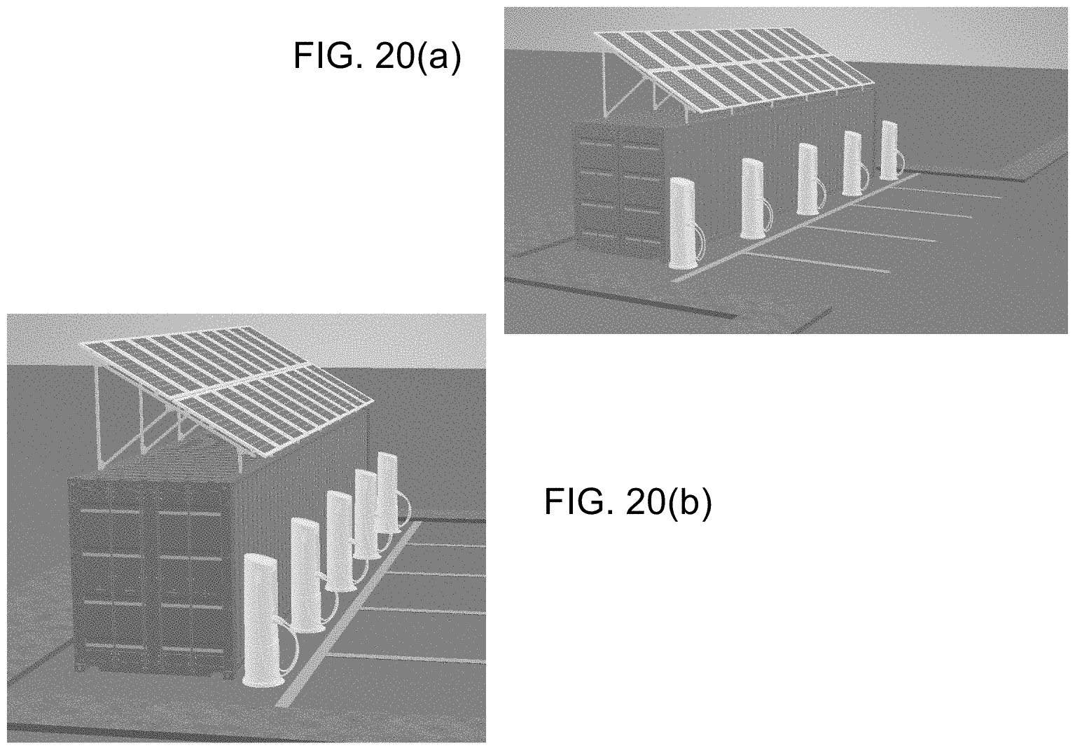

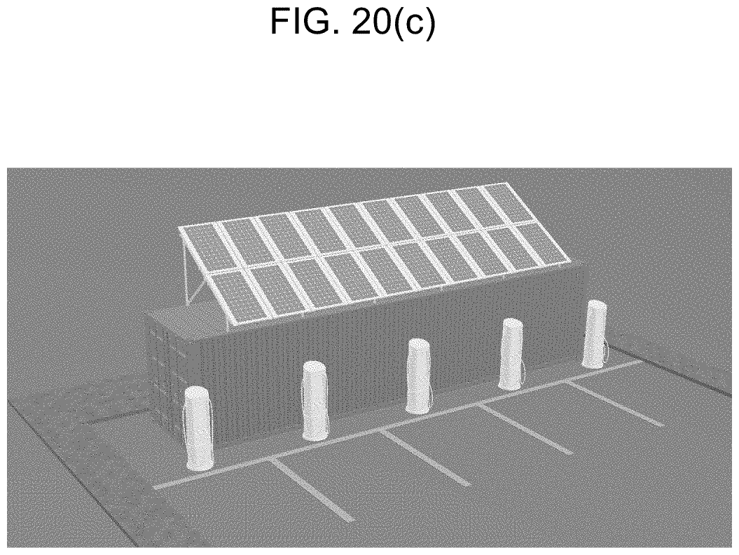

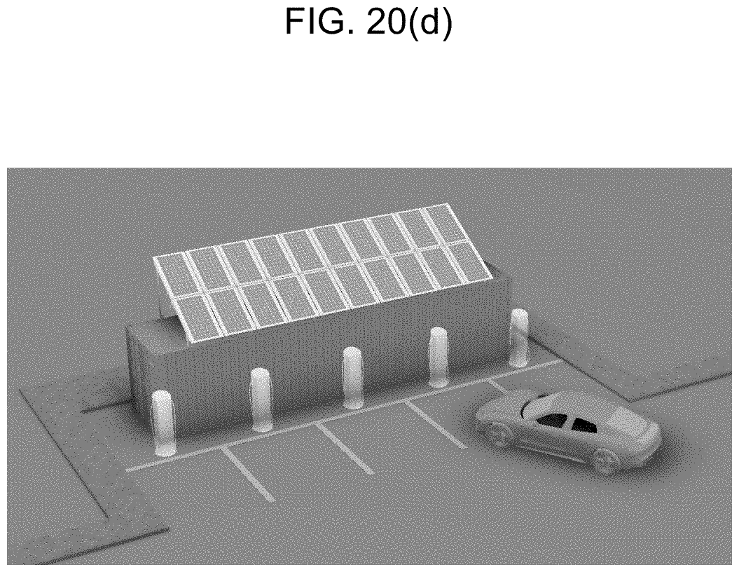

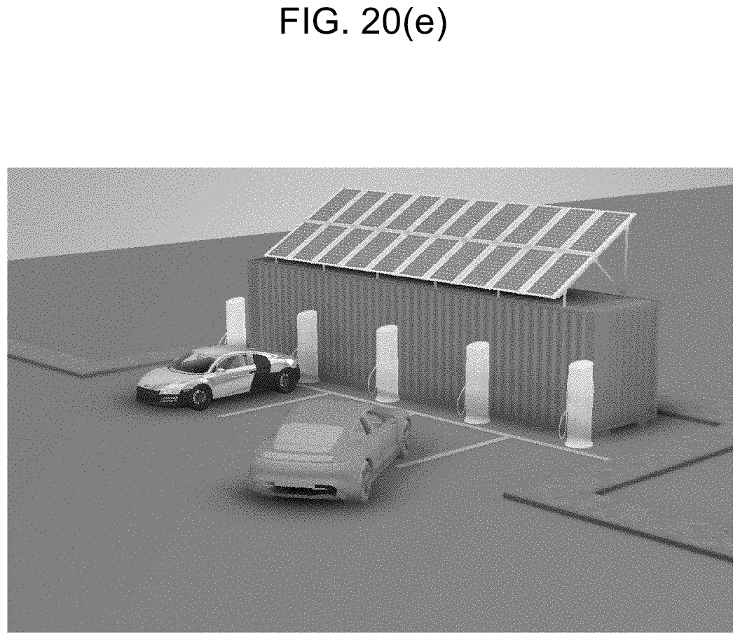

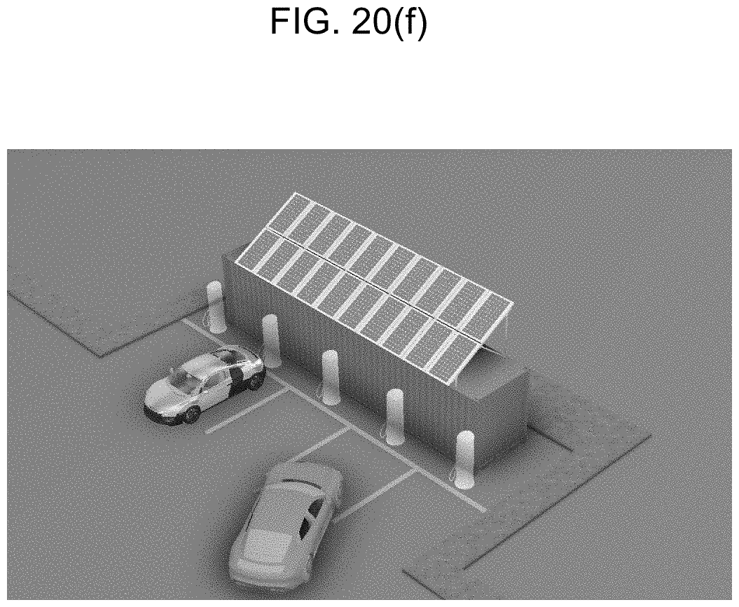

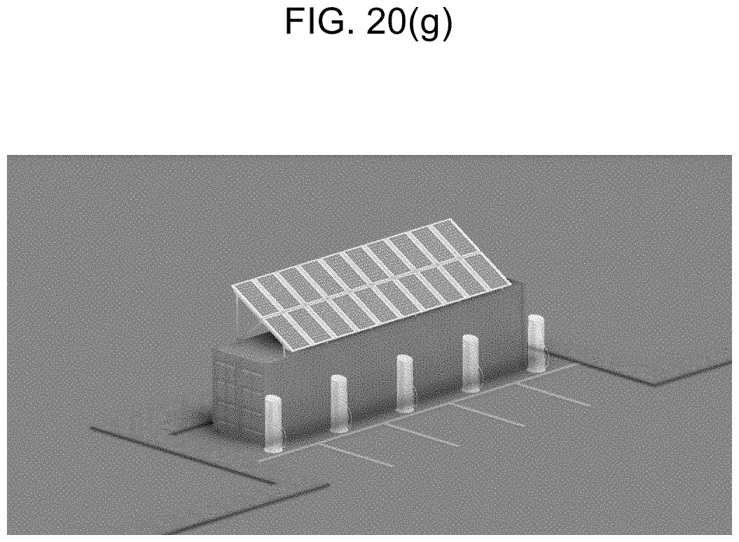

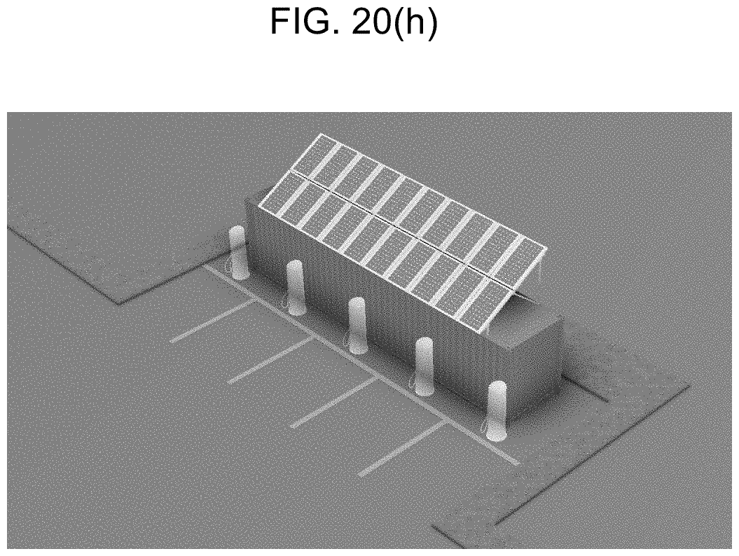

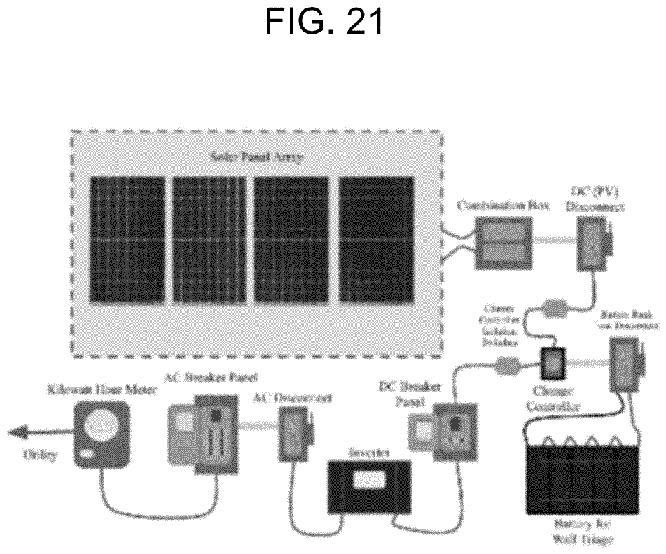

FIGS. 20(a) and 20(h) illustrate schematic diagrams of a solar charging station according to an embodiment herein. As shown in the figures, the disclosed solar energy support system includes a number of solar panels (e.g., twenty solar panels are shown in FIG. 20(a) on a top section of the deployable charging station). In addition to being incorporated into the disclosed deployable charging station (e.g., as shown in FIG. 20(a)), the disclosed solar energy support system is shown in FIG. 21 as including: a solar panel array; a combination box; a DC (PV) Disconnect; Change Controller Isolation Switches; a Change Controller; a Battery Bank Fuse Disconnect and a Battery (e.g., Battery bank for Wall Triage); a DC Breaker Panel; Inverter; an AC Disconnect; an AC Breaker Panel; and a Kilowatt Hour Meter. However, one of ordinary skill in the art will readily recognize that there could be variations to FIGS. 20(a)-20(h) and those variations would be within the spirit and scope of the claimed invention.

For example, while not shown in the figures, an embodiment of the charging station according to FIG. 20(a) includes a grid-tied power center, all housed within the charging station. Such charging centers may be located according to need of the overall deployable system (e.g., barrier system and sound barrier system disclosed herein) and supporting solar panel array. Such an embodiment may further include a complimenting triage station. The electricity harvested serve a dual purpose of powering the triage stations along the deployable barrier system and delivering energy to the utility grid. Triage stations may include charging stations, shelters, medical facilities, repose stations, holding cells, and surveillance monitoring stations. As show in FIG. 21, a portion of the electricity harvested by the solar panels will optionally be sent back to a public grid; for example, to be publicly available following the charging of the triage station batteries. Thus, for example, with each 40-foot section equipped with eight 320 W solar panels, a mile stretch of the disclosed sound barrier system would produce ˜801.7 MW of power annually or enough energy to power 72 average homes.

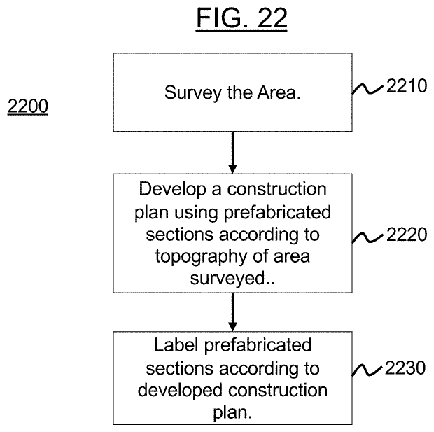

FIG. 22 illustrates schematic diagram of a management method 2200 according to an embodiment herein. As shown, management method 2200 is a method of planning and deploying a deployable barrier according to the embodiments described herein. As discussed above, step 2210 includes surveying the area where the disclosed barrier system will be deployed. Step 2220 includes developing a construction plan using prefabricated sections (e.g., the prefabricated sections described above) according to the topography of the area surveyed. While not shown in FIG. 22, management method 2200 optionally includes creating a timetable of deployment in step 2220, where the timetable incorporates the topography of the area surveyed and the construction requirements unique to that topography. Finally, step 2230 includes labeling the prefabricated sections according to the construction plan. While not shown in FIG. 22, management method 2200 optionally includes repair parameters and specifications for each label to either repair or replace each prefabricated section of the disclosed deployable barrier system.

The techniques provided by the embodiments herein (e.g., the management method shown in FIG. 22 and described above) may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from low-end applications (such as toys, learning tools, models, etc.) to advanced computer products having a display, a keyboard or other input device, and a central processor.

The embodiments herein can take the form of an entirely hardware embodiment, an entirely software embodiment or an embodiment including both hardware and software elements. The embodiments that are implemented in software include but are not limited to, firmware, resident software, microcode, etc.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

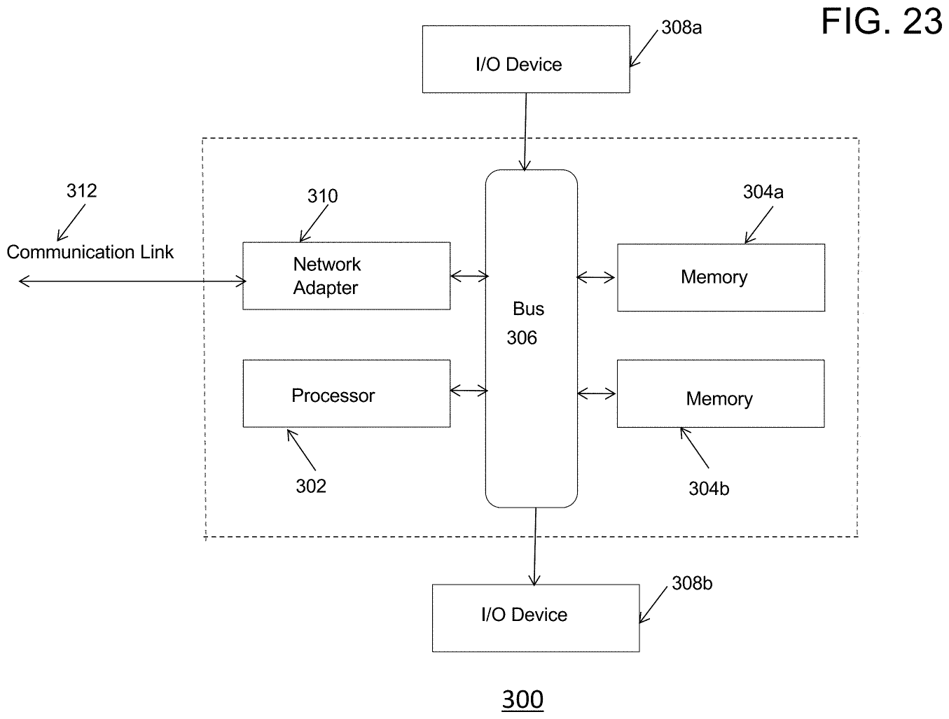

A representative hardware environment for practicing the embodiments herein is depicted in FIG. 23. FIG. 23 illustrates a data processing system 300 suitable for storing the computer program product and/or executing program code in accordance with one or more embodiments of the present invention. The data processing system 300 includes a processor 302 coupled to memory elements 304a-b through a system bus 306. In other embodiments, the data processing system 300 may include more than one processor and each processor may be coupled directly or indirectly to one or more memory elements through a system bus.

Memory elements 304a-b can include local memory employed during actual execution of the program code, bulk storage, and cache memories that provide temporary storage of at least some program code in order to reduce the number of times the code must be retrieved from bulk storage during execution. As shown, input/output or I/O devices 308a-b (including, but not limited to, keyboards, displays, pointing devices, etc.) are coupled to the data processing system 300. I/O devices 308a-b may be coupled to the data processing system 300 directly or indirectly through intervening I/O controllers (not shown).

Further, in FIG. 23, a network adapter 310 is coupled to the data processing system 302 to enable data processing system 300 to become coupled to other data processing systems or remote printers or storage devices through communication link 312. Communication link 312 can be a private or public network. Modems, cable modems, and Ethernet cards are just a few of the currently available types of network adapters.

Additionally, in one or more preferred embodiments, the data processing system 300 of FIG. 23 may further include logic and controllers suitable for executing program code in accordance with one or more embodiments of the present invention.

For instance, the data processing system 300 may include a plurality of processors at 302, wherein each processor may pre-process, process or post-process data (such as but not limited to detection device information, data and sensor data) that is received or transmitted in relation to the detection devices, the connectable devices and other data gathering devices in relation to the predetermined location and association with sound detection of a system and method in accordance with the claimed invention.

In the described embodiments, the system and method may include any circuit, software, process and/or method, including an improvement to an existing systems, for instance.

Although the present invention has been described in accordance with the embodiments shown, one of ordinary skill in the art will readily recognize that there could be variations to the embodiments and those variations would be within the spirit and scope of the claimed invention, such as the inclusion of circuits, electronic devices, control systems, and other electronic and processing equipment. Accordingly, many modifications may be made by one of ordinary skill in the art without departing from the spirit and scope of the appended claims. Many other embodiments of the present invention are also envisioned.

Any theory, mechanism of operation, proof, or finding stated herein is meant to further enhance understanding of the present invention and is not intended to make the present invention in any way dependent upon such theory, mechanism of operation, proof, or finding. It should be understood that while the use of the word preferable, preferably or preferred in the description above indicates that the feature so described may be more desirable, it nonetheless may not be necessary and embodiments lacking the same may be contemplated as within the scope of the invention, that scope being defined by the claims that follow.

What is claimed is:

1. A system for rapidly barrier deployment, comprising:
a plurality of prefabricated segments, each having a top, a bottom, first and second sides, and first and second ends;
arranging the prefabricated segments to form a barrier.

2. The system of claim 1, wherein each prefabricated segment comprises a shipping container.

3. The system of claim 2, wherein each container includes a box-like frame of steel members, a bottom wall and a top wall connected to said frame, two opposed sidewalls of corrugated steel sheet welded to said frame, and two opposed steel endwalls connected to said frame.

4. The system of claim 3, wherein said prefabricated segments are mounted on weight-bearing foundations located under said endwalls and being joined together in vertically adjacent relationship.

5. The system of claim 3, wherein at least one of the containers is filled with granular materials.

6. The system of claim 5, wherein the granular materials includes sand.

7. An apparatus comprising:
a parallelepiped frame;
a plurality of outer walls fixed to the frame such that each outer side of the apparatus is formed by a different one of the plurality of outer walls;
a floor forming a bottom of the apparatus and a ceiling forming a top of the apparatus, the floor and ceiling being fixed to the frame; and
an inner wall fixed to the frame to form an inner side of the apparatus, the inner wall being adjacent to one of the outer walls; the adjacent one outer wall being removeably fixed to the frame so as to be removable to transition the apparatus from a shipping container configuration, in which the plurality of outer walls are affixed to the frame, to a barrier fixture configuration, in which the inner wall is an external wall of a deployable barrier.

8. The apparatus of claim 7, wherein the frame further comprises an ISO 1161 certified corner fitting at each corner and wherein the corner fittings are positioned on the frame to meet the positional requirements specified in ISO 668.

9. The apparatus of claim 7, wherein the frame, the floor, the ceiling and the plurality of outer walls have a combined structural integrity sufficient to pass ISO 1496 stacking, lifting, restraint and racking tests.

10. The apparatus of claim 7, wherein the frame comprises two longitudinal top members having a hollow rectangular cross-section of a first thickness and wherein the remaining frame members have a hollow square cross section of a thickness less than the first thickness.

11. The apparatus of claim 7, further comprising a watertight seal and wherein the frame, the floor, the ceiling and the plurality of outer walls are fixed together with the watertight seal so as to pass an ISO 1496 weathertightness test.

12. The apparatus of claim 7, wherein the frame comprises at least two transverse bottom members providing load transfer areas meeting the requirements for certification under ISO 668.

13. The apparatus of any claim 7, wherein the external dimensions of the apparatus as defined by the frame, the floor, the ceiling and the plurality of outer walls meet the requirements for certification under ISO 668.

14. The apparatus of claim 7, wherein at least one outer wall comprises markings sufficient to meet the requirements for certification under ISO 6346.

15. A deployable barrier system for closing a security area to passage therethrough, the barrier system comprising:
at least one deployable prefabricated segment which is movable between an undeployed position in which the prefabricated segment is disposed in a first location in which the security area is open to passage therethrough, and a fully deployed position in which the prefabricated segment is disposed in a second location different from the first location, whereby the security area is closed to any such passage therethrough, the prefabricated segment being comprised of a ballistic material along substantially its entire length;
a control system operatively connected to controlled prefabricated segment and capable of being activated to move the controlled prefabricated segment between the undeployed position and the fully deployed position;
wherein the controlled prefabricated segment is configured to enable, at a selected time after controlled prefabricated segment is in the fully deployed position, formation in the fully deployed prefabricated segment of at least one limited access opening to the security area.

16. The deployable barrier system of claim 15, wherein the prefabricated segments comprise a shipping container.

17. The deployable barrier system of claim 15, further comprising one or more communication paths which automatically transmit signals to a remote emergency response facility when the control system is activated.

18. The deployable barrier system of claim 15, further comprising a detection system which detects the presence of an intruder or intruders in the security area and transmits an alarm to alert security personnel to activate the control system.

19. The deployable barrier system of claim 15, further comprising a solar energy support system.

20. The deployable barrier system of claim 15, further comprising rail system to transport at least one of persons and cargo.
